(19) United States
(12) Patent Application Publication
(10) Pub. No.: US 2019/0332413 A1
(43) Pub. Date: Oct. 31, 2019

(54) MIGRATION OF SERVICES OF INFRASTRUCTURE MANAGEMENT VIRTUAL MACHINES TO CONTAINERS

(71) Applicant: Nutanix, Inc., San Jose, CA (US)

(72) Inventors: Aman Nijhawan, Seattle, WA (US); Abhishek Arora, Mountain View, CA (US); Akshay Anand Khole, Sunnyvale, CA (US); Aroosh Sohi, Los Gatos, CA (US); VS Kalyan Ram Chintalapati, Santa Clara, CA (US); Nikhil Bhatia, Fremont, CA (US)

(73) Assignee: Nutanix, Inc., San Jose, CA (US)

(21) Appl. No.: 15/967,278

(22) Filed: Apr. 30, 2018

(51) Int. Cl. G06F 9/455

(52) U.S. Cl. CPC G06F 9/45558; G06F 2009/45595; G06F 2009/45583; G06F 2009/4557

(57) ABSTRACT

Examples described herein may include migration of services of infrastructure management virtual machines to a container. An example method includes creating an infrastructure management virtual machine configured to manage and monitor a cluster of nodes of a computing system. The infrastructure management virtual machine including a plurality of services and an associated virtual disk storing data associated with running the plurality of services. The example method further includes extracting a service of the plurality of services running on the infrastructure management virtual machine, and creating a container on a controller virtual machine running on a node of a computing system. The container includes the extracted service. The example method further includes retrieving data associated with the extracted service from the virtual disk, and after retrieved the data, starting the extracted service in the container.

### TECHNICAL FIELD

Examples described herein relate generally to distributed computing systems. Examples of virtualized systems are described. container management tools are provided in some examples of distributed computing systems described herein to facilitate migration of services of infrastructure management virtual machines to a container.

### BACKGROUND

A virtual machine (VM) generally refers to a software-based implementation of a machine in a virtualization environment, in which the hardware resources of a physical computer (e.g., CPU, memory, etc.) are virtualized or transformed into the underlying support for the fully functional virtual machine that can run its own operating system and applications on the underlying physical resources just like a real computer.

Virtualization generally works by inserting a thin layer of software directly on the computer hardware or on a host operating system. This layer of software contains a virtual machine monitor or “hypervisor” that allocates hardware resources dynamically and transparently. Multiple operating systems may run concurrently on a single physical computer and share hardware resources with each other. By encapsulating an entire machine, including CPU, memory, operating system, and network devices, a virtual machine may be completely compatible with most standard operating systems, applications, and device drivers. Most modern implementations allow several operating systems and applications to safely run at the same time on a single computer, with each having access to the resources it needs when it needs them.

One reason for the broad adoption of virtualization in modern business and computing environments is because of the resource utilization advantages provided by virtual machines. Without virtualization, if a physical machine is limited to a single dedicated operating system, then during periods of inactivity by the dedicated operating system the physical machine may not be utilized to perform useful work. This may be wasteful and inefficient if there are users on other physical machines which are currently waiting for computing resources. Virtualization allows multiple VMs to share the underlying physical resources so that during periods of inactivity by one VM, other VMs can take advantage of the resource availability to process workloads. This can produce great efficiencies for the utilization of physical devices, and can result in reduced redundancies and better resource cost management.

### BRIEF DESCRIPTION OF THE DRAWINGS

To easily identify the discussion of any particular element or act, the most significant digit or digits in a reference number refer to the figure number in which that element is first introduced.

FIG. 1 is a block diagram of a distributed computing system, in accordance with an embodiment of the present disclosure.

FIG. 2 a block diagram of depicting migration of IMVM services to a respective containers in accordance with some embodiments of the disclosure.

FIG. 3 a block diagram of depicting an exemplary configuration of an IMVM service that has migrated to a respective containers in accordance with some embodiments of the disclosure.

FIG. 4 depicts a block diagram of components of a computing node in accordance with an embodiment of the present disclosure.

### DETAILED DESCRIPTION

This disclosure describes embodiments for migration of services/applications of infrastructure management virtual machines (IMVMs) to containers (e.g., a docker container, a Linux container, or any other construct that is capable of holding a set of processes that are isolated from the rest of the system, running from a distinct image that provides all files necessary to support the processes). Generally, a container may refer to a standalone/self-contained executable package of software that includes an entire runtime environment, including an application and dependencies, libraries, binaries, configurations files, etc. to run the application. Containers are tools that may allow many different applications to coexist on a single server without interfering or interacting with each other. The container acts as a boundary within a computer system that can control which computing resources, interfaces, other applications, etc. that are available and visible to the application. From the perspective of the application, the container may look like it is providing access to the entire computing system, even though it only actually aware of a portion of the computing system permitted to be visible and accessible by from the container. Moving services/applicants to containers, in some examples, may be a computing-resource-efficient alternative to a virtual machine due to decreased overhead processes and an ability to replicate a subset of services/applicants (e.g., as opposed to a VM that requires an entire set of services/applications to operate). Generally, IMVMs provide a central infrastructure resource to monitor and manage multiple clusters of nodes in a virtual computing environment. IMVMs can, in some examples, consume significant computing resources, and may effectively render a host computing node inoperable for other functions, especially in systems that include multiple IMVMs. Migrating the functionality (e.g., the services) of the IMVMs to containers may provide a more computing-resource-efficient and configurable alternative to the IMVMs.

Various embodiments of the present disclosure will be explained below in detail with reference to the accompanying drawings. The following detailed description refers to the accompanying drawings that show, by way of illustration, specific aspects and embodiments of the disclosure. The detailed description includes sufficient detail to enable those skilled in the art to practice the embodiments of the disclosure. Other embodiments may be utilized, and structural, logical and electrical changes may be made without departing from the scope of the present disclosure. The various embodiments disclosed herein are not necessary mutually exclusive, as some disclosed embodiments can be combined with one or more other disclosed embodiments to form new embodiments.

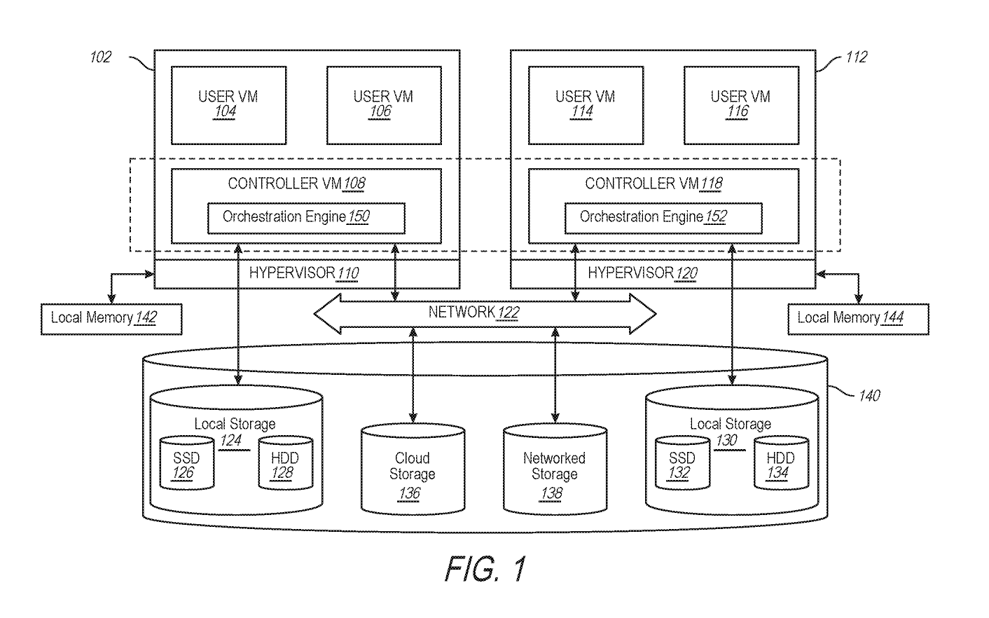

FIG. 1 is a block diagram of a distributed computing system, in accordance with an embodiment of the present disclosure. The distributed computing system of FIG. 1 generally includes computing node 102 and computing node 112 and storage 140 connected to a network 122. The network 122 may be any type of network capable of routing data transmissions from one network device (e.g., computing node 102, computing node 112, and storage 140) to another. For example, the network 122 may be a local area network (LAN), wide area network (WAN), intranet, Internet, or a combination thereof. The network 122 may be a wired network, a wireless network, or a combination thereof.

The storage 140 may include local storage 124, local storage 130, cloud storage 136, and networked storage 138. The local storage 124 may include, for example, one or more solid state drives (SSD 126) and one or more hard disk drives (HDD 128). Similarly, local storage 130 may include SSD 132 and HDD 134. Local storage 124 and local storage 130 may be directly coupled to, included in, and/or accessible by a respective computing node 102 and/or computing node 112 without communicating via the network 122. Cloud storage 136 may include one or more storage servers that may be stored remotely to the computing node 102 and/or computing node 112 and accessed via the network 122. Other nodes, however, may access the local storage 124 and/or the local storage 130 using the network 122. The cloud storage 136 may generally include any type of storage device, such as HDDs SSDs, or optical drives. Networked storage 138 may include one or more storage devices coupled to and accessed via the network 122. The networked storage 138 may generally include any type of storage device, such as HDDs SSDs, and/or NVM Express (NVMe). In various embodiments, the networked storage 138 may be a storage area network (SAN). The computing node 102 is a computing device for hosting virtual machines (VMs) in the distributed computing system of FIG. 1. The computing node 102 may be, for example, a server computer. The computing node 102 may include one or more physical computing components, such as processors.

The computing node 102 is configured to execute a hypervisor 110, a controller VM 108 and one or more user VMs, such as user VMs 104, 106. The user VMs including user VM 104 and user VM 106 are virtual machine instances executing on the computing node 102. The user VMs including user VM 104 and user VM 106 may share a virtualized pool of physical computing resources such as physical processors and storage (e.g., storage 140). The user VMs including user VM 104 and user VM 106 may each have their own operating system, such as Windows or Linux. While a certain number of user VMs are shown, generally any number may be implemented. User VMs may generally be provided to execute any number of applications and services desired by a user.

The hypervisor 110 may be any type of hypervisor. For example, the hypervisor 110 may be ESX, ESX(i), Hyper-V, KVM, or any other type of hypervisor. The hypervisor 110 manages the allocation of physical resources (such as storage 140 and physical processors) to VMs (e.g., user VM 104, user VM 106, and controller VM 108) and performs various VM related operations, such as creating new VMs and cloning existing VMs. Each type of hypervisor may have a hypervisor-specific API through which commands to perform various operations may be communicated to the particular type of hypervisor. The commands may be formatted in a manner specified by the hypervisor-specific API for that type of hypervisor. For example, commands may utilize a syntax and/or attributes specified by the hypervisor-specific API.

Controller VMs (CVMs) described herein, such as the controller VM 108 and/or controller VM 118, may provide services for the user VMs in the computing node. As an example of functionality that a controller VM may provide, the controller VM 108 may provide virtualization of the storage 140. Controller VMs may provide management of the distributed computing system shown in FIG. 1. Examples of controller VMs may execute a variety of software and/or may serve the I/O operations for the hypervisor and VMs running on that node. In some examples, a SCSI controller, which may manage SSD and/or HDD devices described herein, may be directly passed to the CVM, e.g., leveraging PCI Pass-through in some examples. In this manner, controller VMs described herein may manage input/output (I/O) requests between VMs on a computing node and available storage, such as storage 140.

The computing node 112 may include user VM 114, user VM 116, a controller VM 118, and a hypervisor 120. The user VM 114, user VM 116, the controller VM 118, and the hypervisor 120 may be implemented similarly to analogous components described above with respect to the computing node 102. For example, the user VM 114 and user VM 116 may be implemented as described above with respect to the user VM 104 and user VM 106. The controller VM 118 may be implemented as described above with respect to controller VM 108. The hypervisor 120 may be implemented as described above with respect to the hypervisor 110. In the embodiment of FIG. 1, the hypervisor 120 may be a different type of hypervisor than the hypervisor 110. For example, the hypervisor 120 may be Hyper-V, while the hypervisor 110 may be ESX(i).

The controller VM 108 and controller VM 118 may communicate with one another via the network 122. By linking the controller VM 108 and controller VM 118 together via the network 122, a distributed network of computing nodes including computing node 102 and computing node 112, can be created. In some examples, the hypervisor 110 may be of a same type as the hypervisor 120.

Controller VMs, such as controller VM 108 and controller VM 118, may each execute a variety of services and may coordinate, for example, through communication over network 122. Services running on controller VMs may utilize an amount of local memory to support their operations. For example, services running on controller VM 108 may utilize memory in local memory 142. Services running on controller VM 118 may utilize memory in local memory 144. The local memory 142 and local memory 144 may be shared by VMs on computing node 102 and computing node 112, respectively, and the use of local memory 142 and/or local memory 144 may be controlled by hypervisor 110 and hypervisor 120, respectively. Moreover, multiple instances of the same service may be running throughout the distributed system—e.g. a same services stack may be operating on each controller VM. For example, an instance of a service may be running on controller VM 108 and a second instance of the service may be running on controller VM 118.

Generally, controller VMs described herein, such as controller VM 108 and controller VM 118 may be employed to control and manage any type of storage device, including all those shown in storage 140 of FIG. 1, including local storage 124 (e.g., SSD 126 and HDD 128), cloud storage 136, and networked storage 138. Controller VMs described herein may implement storage controller logic and may virtualize all storage hardware as one global resource pool (e.g., storage 140) that may provide reliability, availability, and performance. IP-based requests are generally used (e.g., by user VMs described herein) to send I/O requests to the controller VMs. For example, user VM 104 and user VM 106 may send storage requests to controller VM 108 over a virtual bus. Controller VMs described herein, such as controller VM 108, may directly implement storage and I/O optimizations within the direct data access path. Communication between hypervisors and controller VMs described herein may occur using IP requests.

In some examples, the controller VMs may include an orchestration engine (e.g., the orchestration engine 150 and the orchestration engine 152) that facilitates migration of and hosting of services/applications from IMVMs in one or more containers. The orchestration engine may define one or more volume groups that include data for running the services/applications, which may allow a service running on a respective container to access the associated service data. In some examples, the client may include one or more of the user VMs 104, 106, 114, or 118. Controller VMs 108 and 118 may include one or more container management tools to facilitate the migration and operation of the services/applications included in the containers. Orchestration services described herein may utilize the container management tools to perform the data migration and operation associated with a services/applications.

Note that controller VMs are provided as virtual machines utilizing hypervisors described herein—for example, the controller VM 108 is provided behind hypervisor 110. Since the controller VMs run “above” the hypervisors examples described herein may be implemented within any virtual machine architecture, since the controller VMs may be used in conjunction with generally any hypervisor from any virtualization vendor.

Virtual disks (vDisks) may be structured from the storage devices in storage 140, as described herein. A vDisk generally refers to the storage abstraction that may be exposed by a controller VM to be used by a user VM. In some examples, the vDisk may be exposed via iSCSI (“internet small computer system interface”) or NFS (“network file system”) and may be mounted as a virtual disk on the user VM. For example, the controller VM 108 may expose one or more vDisks of the storage 140 the hypervisor 110 may attach the vDisks to one or more VMs, and the virtualized operating system and may mount a vDisk on one or more user VMs, such as user VM 104 and/or user VM 106.

During operation, user VMs (e.g., user VM 104 and/or user VM 106) may provide storage input/output (I/O) requests to controller VMs (e.g., controller VM 108 and/or hypervisor 110). Accordingly, a user VM may provide an I/O request over a virtual bus to a hypervisor as an iSCSI and/or NFS request. Internet Small Computer System Interface (iSCSI) generally refers to an IP-based storage networking standard for linking data storage facilities together. By carrying SCSI commands over IP networks, iSCSI can be used to facilitate data transfers over intranets and to manage storage over any suitable type of network or the Internet. The iSCSI protocol allows iSCSI initiators to send SCSI commands to iSCSI targets at remote locations over a network. In some examples, user VMs may send I/O requests to controller VMs in the form of NFS requests. Network File System (NFS) refers to an IP-based file access standard in which NFS clients send file-based requests to NFS servers via a proxy folder (directory) called “mount point”. Generally, then, examples of systems described herein may utilize an IP-based protocol (e.g., iSCSI and/or NFS) to communicate between hypervisors and controller VMs.

During operation, examples of user VMs described herein may provide storage requests using an IP based protocol, such as SMB. The storage requests may designate the IP address for a controller VM from which the user VM desires I/O services. The storage request may be provided from the user VM to a virtual switch within a hypervisor to be routed to the correct destination. For examples, the user VM 104 may provide a storage request to hypervisor 110. The storage request may request I/O services from controller VM 108 and/or controller VM 118. If the request is to be intended to be handled by a controller VM in a same service node as the user VM (e.g., controller VM 108 in the same computing node as user VM 104) then the storage request may be internally routed within computing node 102 to the controller VM 108. In some examples, the storage request may be directed to a controller VM on another computing node. Accordingly, the hypervisor (e.g., hypervisor 110) may provide the storage request to a physical switch to be sent over a network (e.g., network 122) to another computing node running the requested controller VM (e.g., computing node 112 running controller VM 118).

Accordingly, hypervisors described herein may manage I/O requests between user VMs in a system and a storage pool. Controller VMs may virtualize I/O access to hardware resources within a storage pool according to examples described herein. In this manner, a separate and dedicated controller (e.g., controller VM) may be provided for each and every computing node within a virtualized computing system (e.g., a cluster of computing nodes that run hypervisor virtualization software), since each computing node may include its own controller VM. Each new computing node in the system may include a controller VM to share in the overall workload of the system to handle storage tasks. Therefore, examples described herein may be advantageously scalable, and may provide advantages over approaches that have a limited number of controllers. Consequently, examples described herein may provide a massively-parallel storage architecture that scales as and when hypervisor computing nodes are added to the system.

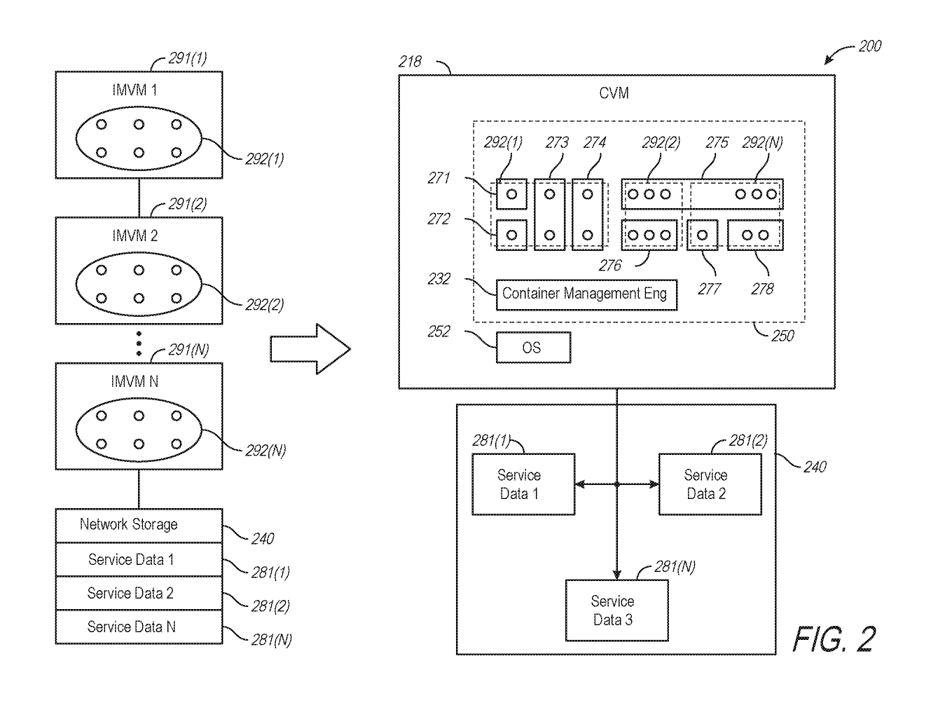

FIG. 2 a block diagram of depicting migration of IMVM services to a respective containers in accordance with some embodiments of the disclosure. In FIG. 2, a system may include multiple IMVMs 291(1)-(N). Each of the IMVMs 291(1)-(N) may include a respective set of services 292(1)-(N). Note that use of the term “service” may be used interchangeable with “application” and may refer to any service or application running on the IMVMs 291(1)-(N). Additionally, while each respective set of services 292(1)-(N) is depicted with 6 services, more or fewer services may be included in a respective set of services without departing from the scope of the disclosure. The IMVMs 291(1)-(N) may interface with network storage 240 to retrieve respective service data 1-N 281(1)-(N). The service data 1-N 281(1)-(N) may include data necessary for each respective service of the set of services 292(1)-(N) to run.

In operation, the IMVMs 291(1)-(N) may monitor and manage one or more clusters of nodes (e.g., the nodes 102 and/or 112 of FIG. 1) in a virtual computing environment, in some examples. In some examples, the IMVMs 292(1)-(N) may each implement Nutanix® Prism Central® for centralized monitoring and management functionality. The IMVMs 291(1)-(N) may be appliances that are each hosted on a single node, each hosted on a difference respective node, or some combination of common and different nodes. As an appliance, the IMVMs 291(1)-(N) may each be allocated specific computing resources to perform the monitor and management functions for the one or more clusters of nodes. Each collective set of services 292(1)-(N) on the IMVMs 291(1)-(N) may perform similar functions for the respective IMVM. For example, one service may manage statistical operations and data, one service ma manage cluster configuration (e.g., Zookeeper), one service may manage gateway layer, one may manage cluster service interaction and initial configuration service, one service may manage virtual machine scheduling, one service may manage a user interface, etc. In some examples, some of the individual services of a particular set of services 262(1)-(N) may communicate other services during operation. For example, a memory access service may communicate with the network interface service to send data to and receive data from the network storage 240. In some examples, implementation of the centralized monitoring and management functionality in the form of monolith appliances, such as the IMVMs 291(1)-(N) may substantially impact available computing resources for normal cluster-related operation of a host node. In some examples, the computing resources consumed by the IMVMs 291(1)-(N) may effectively render a host node unusable for normal cluster-related operations.

Therefore, to move to a more computing resource efficient solution, an orchestration engine 250 operating on a CVM 218 may migrate the individual services of the sets of services 292(1)-(N) from the IMVMs 291(1)-(N) to respective containers 271-278. The migration may include extracting the individual services from the sets of services 292(1)-(N) from the IMVMs 291(1)-(N) and creating the containers 271-278 that include one or more of the extracted services. The migration may also include migration of the service data 281(1)-(N) to facilitate execution of the services. On started, the container management engine 232 may provide an interface for services running in the respective containers 271-278 to communicate within an overall computing system, including communication with the operating system 252 of the CVM 218. The CVM 218 may be implemented in one or more of the CVMs 108 and 118 of FIG. 1. In general, implementation of the centralized monitor and management functions using containers 271-278 may reduce computing resources, as well provide an opportunity for more elastic and precise customization. That is, because the IMVMs 291(1)-(N) are implemented as individual, stand-alone appliances, each of the IMVMs 291(1)-(N) may require a full set of services 292(1)-(N). While FIG. 2 depicts migration of the full set of services 292(1)-(N) from each of the IMVMs 291(1)-(N), use of the containers 271-278 and the container management engine 232, does make it possible to select a subset of individual services from one of the sets of services 292(1)-(N) for migration. The selection of the subset may be based on need or some other criteria. For example, a number of statistical services (e.g., Cassandra), cluster configuration management services (e.g., Zookeeper), gateway layer services, etc., may need to be scaled up or down (e.g., include more or fewer of each respective service) as a number and size of monitored and managed clusters change, while a single instances of each of a clusters service interaction and initial configuration service (e.g., Genesis), virtual machine scheduled service, and user interface service may be sufficient no matter the scale of the monitored systems. That is, using the containers 271-278, additional Zookeeper, Cassandra, and gateway layer services could be implemented without also having to add corresponding Genesis, VM scheduler, or user interface services. The customization reduces both memory usage, and processor usage.

The allocation of individual services among the containers 271-278 depicted in FIG. 2 is exemplary, and includes some containers that only include a single service (e.g., containers 271, 272, and 277) and some containers include multiple services (e.g., containers 273, 274-276, and 278). In some examples, each service may be allocated to different respective container. Additional or different combinations of services within containers may be implemented without departing from the scope of the disclosure. In some examples, combinations of services may be based on type (e.g., one or more network interface services may be included in a single container), based on frequency of communication between services (e.g., a network interface and memory access service may be grouped in a single container based on routine communication between them), or some combination thereof. Each of the containers 271-278 may mount a respective volume group (not shown) that includes respective service data 281(1)-(N) from network storage. The containers 271-278 may retrieve service data from the respective service data 281(1)-(N), which may be used to start and run respective the respective services.

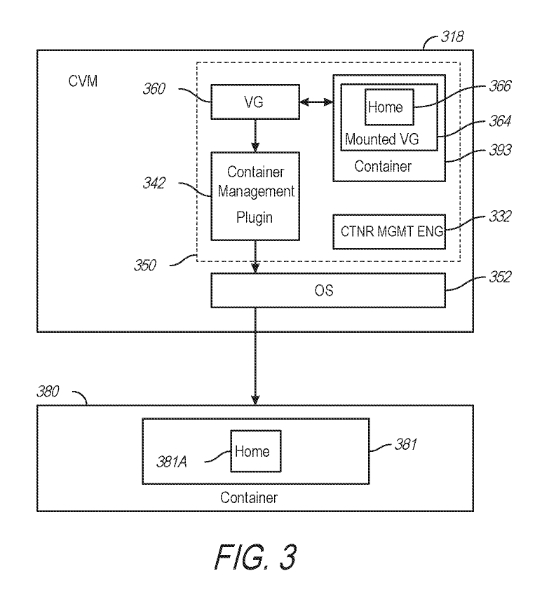

FIG. 3 a block diagram of depicting an exemplary configuration of an IMVM service that has migrated to a respective containers in accordance with some embodiments of the disclosure. FIG. 3 includes a CVM 318 operating an orchestration engine 350 and an operating system 352. The CVM 318 may include the CVMs 108 and/or 118 of FIG. 1 and/or the CVM 218 of FIG. 2. The 350 includes a container management engine 332, a container management plugin 342, a volume group (VG) 360, and a container 393. The VG 360 provides an interface to a storage container 380 and the virtual disk 381. The storage container 380 may be included within network storage of a computing system, such as the network storage 140 of FIG. 1 or the network storage 240 of FIG. 2. The virtual disk 381 may include a home directory 381A that includes data associated with one or more applications or services. The container 393 includes a mounted VG 364, which includes a home directory 366.

In FIG. 3, a virtual disk 381 includes a home directory 381A. The home directory 381A includes data for one or more applications/services, such as a service running in the container 393. The VG 360 provides access to data of the home directory 381A stored on the virtual disk 381. In operation, the container 393 mounts the VG 360 to provide the mounted VG 364. The mounted VG 364 provides a copy of the home directory 381A as the home directory 366. The container 393 may run one or more services within the orchestration engine 350 based on data from the home directory 366. The container 393 may use the container management plugin 342 and the container management engine 332 to interface with computing resources within a virtual computing system. While FIG. 3 includes a single container 393, more containers may be included without departing from the scope of the disclosure. Correspondingly, more virtual disks may be included as necessary to facilitate provision of service data to other containers. The application/service migrated to the container 393 may be from an IMVM.

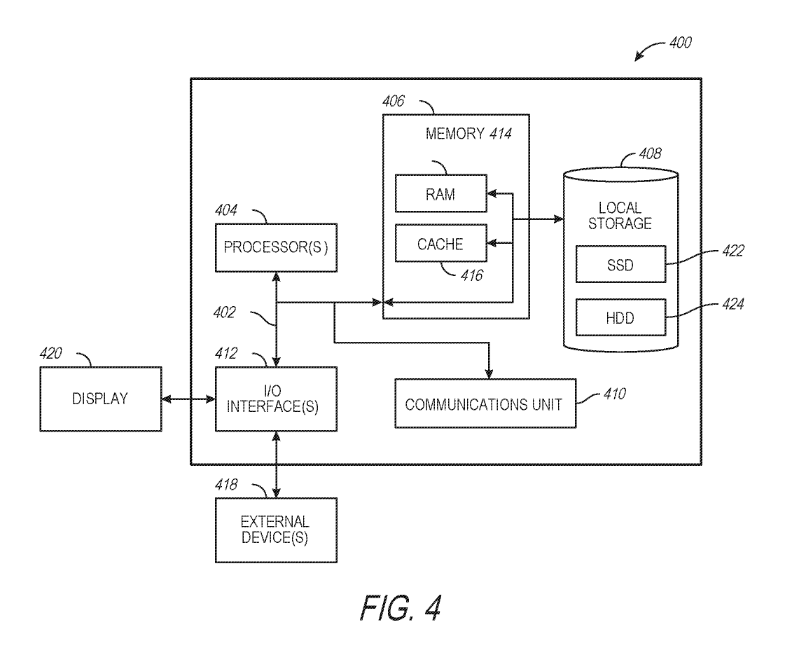

FIG. 4 depicts a block diagram of components of a computing node 400 in accordance with an embodiment of the present disclosure. It should be appreciated that FIG. 4 provides only an illustration of one implementation and does not imply any limitations with regard to the environments in which different embodiments may be implemented. Many modifications to the depicted environment may be made. The computing node 300 may implemented as the computing node 102 and/or computing node 112. The computing node 300 may be configured to implement IMVMs 291(1)-(N) and/or the CVM 218 of FIG. 2, the CVM 318 of FIG. 3, or combinations thereof, in some examples, to migrate data associated with a service running on any IMVM.

The computing node 400 includes a communications fabric 402, which provides communications between one or more processor(s) 404, memory 406, local storage 408, communications unit 410, I/O interface(s) 412. The communications fabric 402 can be implemented with any architecture designed for passing data and/or control information between processors (such as microprocessors, communications and network processors, etc.), system memory, peripheral devices, and any other hardware components within a system. For example, the communications fabric 402 can be implemented with one or more buses.

The memory 406 and the local storage 408 are computer-readable storage media. In this embodiment, the memory 406 includes random access memory RAM 414 and cache 416. In general, the memory 406 can include any suitable volatile or non-volatile computer-readable storage media. The local storage 408 may be implemented as described above with respect to local storage 124 and/or local storage 130. In this embodiment, the local storage 408 includes an SSD 422 and an HDD 424, which may be implemented as described above with respect to SSD 126, SSD 132 and HDD 128, HDD 134 respectively.

Various computer instructions, programs, files, images, etc. may be stored in local storage 408 for execution by one or more of the respective processor(s) 404 via one or more memories of memory 406. In some examples, local storage 408 includes a magnetic HDD 424. Alternatively, or in addition to a magnetic hard disk drive, local storage 408 can include the SSD 422, a semiconductor storage device, a read-only memory (ROM), an erasable programmable read-only memory (EPROM), a flash memory, or any other computer-readable storage media that is capable of storing program instructions or digital information.

The media used by local storage 408 may also be removable. For example, a removable hard drive may be used for local storage 408. Other examples include optical and magnetic disks, thumb drives, and smart cards that are inserted into a drive for transfer onto another computer-readable storage medium that is also part of local storage 408.

Communications unit 410, in these examples, provides for communications with other data processing systems or devices. In these examples, communications unit 410 includes one or more network interface cards. Communications unit 410 may provide communications through the use of either or both physical and wireless communications links.

I/O interface(s) 412 allows for input and output of data with other devices that may be connected to computing node 400. For example, I/O interface(s) 412 may provide a connection to external device(s) 418 such as a keyboard, a keypad, a touch screen, and/or some other suitable input device. External device(s) 418 can also include portable computer-readable storage media such as, for example, thumb drives, portable optical or magnetic disks, and memory cards. Software and data used to practice embodiments of the present disclosure can be stored on such portable computer-readable storage media and can be loaded onto local storage 408 via I/O interface(s) 412. I/O interface(s) 412 also connect to a display 420.

Display 420 provides a mechanism to display data to a user and may be, for example, a computer monitor.

Although this disclosure has been disclosed in the context of certain preferred embodiments and examples, it will be understood by those skilled in the art that the disclosures extend beyond the specifically disclosed embodiments to other alternative embodiments and/or uses of the disclosures and obvious modifications and equivalents thereof. In addition, other modifications which are within the scope of this disclosure will be readily apparent to those of skill in the art based on this disclosure. It is also contemplated that various combination or sub-combination of the specific features and aspects of the embodiments may be made and still fall within the scope of the disclosures. It should be understood that various features and aspects of the disclosed embodiments can be combined with or substituted for one another in order to form varying mode of the disclosed disclosure. Thus, it is intended that the scope of at least some of the present disclosure herein disclosed should not be limited by the particular disclosed embodiments described above.

1. A method comprising:
creating an infrastructure management virtual machine including a plurality of services and an associated virtual disk storing data associated with running the plurality of services;
extracting a service of the plurality of services configured to run on the infrastructure management virtual machine;
creating a container on a controller virtual machine running on a node of a computing system, wherein the container includes the extracted service;
retrieving data associated with the extracted service from the virtual disk; and
after retrieval of the data, starting the extracted service in the container.

2. The method of claim 1, further comprising:
extracting a second service of the plurality of services configured to run on the infrastructure management virtual machine;
creating a second container on the controller virtual machine, wherein the second container includes the second extracted service;
retrieving second data associated with the second extracted service from the virtual disk; and
after retrieval of the data, starting the second extracted service in the second container.

3. The method of claim 1, further comprising:
extracting a second service of the plurality of services configured to run on the infrastructure management virtual machine;
including the second extracted service on the container of the controller virtual machine;
retrieving second data associated with the second extracted service from the virtual disk; and
after retrieval of the data, starting the second extracted service in the container.

4. The method of claim 1, wherein retrieving data associated with the extracted service from the virtual disk comprises loading a home directory on the container.

5. The method of claim 1, further comprising:
creating a volume group that is associated with the virtual disk; and
mounting the volume group on the container, wherein the home directory is loaded via the volume group.

6. The method of claim 1, further comprising:
creating a second infrastructure management virtual machine including a second plurality of services and a second associated virtual disk storing data associated with running the second plurality of services;
extracting a second service of the second plurality of services configured to run on the second infrastructure management virtual machine;
creating a second container within the controller virtual machine at a node of the computing system, wherein the second container includes the second extracted service;
retrieving data associated with the second extracted service from the second virtual disk; and
after retrieval of the second data, starting the second extracted service in the second container.

7. The method of claim 1, further comprising:
creating a second infrastructure management virtual machine including a second plurality of services and a second associated virtual disk storing data associated with running the second plurality of services;
extracting a second service of the second plurality of services configured to run on the second infrastructure management virtual machine;
including the second extracted service on the container of the controller virtual machine;
retrieving data associated with the second extracted service from the second virtual disk; and
after retrieval of the second data, starting the second extracted service in the container.

8. The method of claim 7, wherein the second extracted service performs a function that is the same as a function performed by the extracted service.

9. The method of claim 7, wherein the second extracted service performs a function that is different from a function performed by the extracted service.

10. Computer readable media encoded with instructions that, when executed by the at least one processor, cause a computing node to:
extract a service of a plurality of services configured to run on an infrastructure management virtual machine having an associated virtual disk configured to store data associated with running the plurality of services;
create a container in a virtual machine running on a node of the computing system, wherein the container includes the extracted service;
retrieve data associated with the extracted service from the virtual disk; and
after retrieval of the data, start the extracted service in the container.

11. The computer readable media of claim 10, wherein the instructions further cause the computing node to start a container management application and a container management tool plugin to facilitate execution of the service within the container.

12. The computer readable media of claim 10, wherein the instructions further cause the computing node to:
create a volume group mapped to the virtual disk, and
mount the volume group on the container to facilitate retrieval of the data.

13. The computer readable media of claim 10, wherein the instructions further cause the computing node to, prior to extraction of the service, create the infrastructure management virtual machine including the plurality of services.

14. The computer readable media of claim 10, wherein the instructions further cause the computing node to:
extract a second service of the plurality of services configured to run on the infrastructure management virtual machine;
create a second container in the virtual machine running on the node of the computing system, wherein the second container includes the extracted service;
retrieve data associated with the extracted service from the virtual disk; and
after retrieval of the data, start the extracted service in the container.

15. The computer readable media of claim 10, wherein the instructions further cause the computing node to:
extract a second service of the plurality of services configured to run on the infrastructure management virtual machine;
include the second extracted service on the container of the controller virtual machine retrieve data associated with the extracted service from the virtual disk; and
after retrieval of the data, start the extracted service in the container.

16. The computer readable media of claim 10, wherein the instructions further cause the computing node to:
extract a second service of a second plurality of services configured to run on a second infrastructure management virtual machine configured to manage and monitor the cluster of nodes of the computing system;
including the second extracted service on the container of the controller virtual machine;
retrieving data associated with the second extracted service from the second virtual disk; and
after retrieval of the second data, starting the second extracted service in the container.

17. The computer readable media of claim 16, wherein the second extracted service performs a function that is the same as a function performed by the extracted service.

18. The computer readable media of claim 16, wherein the second extracted service performs a function that is different from a function performed by the extracted service.

19. A computing system comprising:
a first computing node of a plurality of computing nodes is configured to:
extract a service of a plurality of services configured to run on an infrastructure management virtual machine including an associated virtual disk storing data associated with running the plurality of services;
create a container in a controller virtual machine running on the first computing node, wherein the container includes the extracted service;
retrieve data associated with the extracted service from the virtual disk; and
after retrieval of the data, start the extracted service in the container.

20. The computing system of claim 19, wherein the first computing node of the plurality of computing nodes is further configured to:
extract a second service of a second plurality of services configured to run on a second infrastructure management virtual machine configured to manage and monitor the cluster of nodes of the computing system;
including the second extracted service on the container of the controller virtual machine;
retrieving data associated with the second extracted service from the second virtual disk; and
after retrieval of the second data, starting the second extracted service in the container.
